(19) United States
(12) Patent Application Publication
(10) Pub. No.: US 2005/0206241 A1
(43) Pub. Date: Sep. 22, 2005

(54) Web-enabled UPS

(76) Inventors: Piyush Saxena, Cranston, RI (US); Matthew F. Bush, Tyngsboro, MA (US); Mark H. Germagian, Hudson, MA (US); Colin Campbell, Groton, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/802,190

(22) Filed: Mar. 17, 2004

(51) Int. Cl. H02J 7/00

(52) U.S. Cl. 307/66

(57) ABSTRACT

A UPS for providing AC power to a load includes an input to receive AC power, an output to provide AC power to the load, a DC voltage source, an inverter coupled to the DC voltage source, a transfer switch coupled to the input, the inverter, and the output, a first controller coupled to the transfer switch and configured to control the transfer switch to selectively couple the input or the inverter to the output, a network interface coupled to the first controller and configured to communicate with a computing device via a network and with the first controller to transfer data between the first controller and the computing device and to provide commands from the computing device to the first controller, and a housing including a chassis configured to be mounted to a wall and to support the UPS when mounted to a vertical wall.

### FIELD OF THE INVENTION

The invention relates to interfacing with an uninterruptible power supply (UPS) to monitor and/or control the UPS.

### BACKGROUND OF THE INVENTION

Today's companies and persons rely on having power more than ever before. Without power, companies may be unable to manufacture goods, or to operate at all, such as if the company is in the business of supplying information over the Internet. Without power, businesses and individuals may be completely incapacitated regarding critical activities, such as making goods, providing services, and transacting personal finances (e.g., filing tax returns, and paying bills).

With such a heavy reliance on power, individuals and companies frequently need to be able to have power outages corrected in short order, and/or have backup power supplies so that their affairs and/or businesses are not significantly affected, and/or be notified when power fails. Correcting power outages typically involves calling a local power company to report a power outage and/or troubleshooting a local power supply/conveyance system, e.g., internal to a company or residence, that has gone out. Uninterruptible power supplies (UPSs) are often used to provide backup power in case of a power outage. A UPS provides surge protection and backup battery power for electronic systems. Backup battery power helps prevent loss of data that can occur during a blackout, a brownout (low voltage), or a spike or a surge of electricity through the system. UPSs are commonly used on computing equipment to guard against data being lost due to a power outage before the data are saved. UPSs used with computing equipment also help to guard against a loss in service by providers of information over the Internet, such as by servers, e.g., hosting web pages. UPSs can also help improve availability of network infrastructure in the home during power outages, protect against data loss on personal computers, etc.

### SUMMARY OF THE INVENTION

In general, in an aspect, the invention provides an uninterruptible power supply (UPS) for providing AC power to a load in a local area network, the local area network including at least one computing device, the UPS including an input configured to receive an AC power connector and to receive AC power through the AC power connector, an output configured to couple to another AC power connector and to provide AC power to the load through the another AC power connector, a DC voltage source configured to provide DC power, the DC voltage source including an energy storage device, an inverter coupled to the DC voltage source and configured to receive DC power from the DC voltage source and to convert the received DC power to AC power, a transfer switch coupled to the input and to the inverter and configured to selectively couple one of the input and the inverter to the output to provide AC power to the output, a first controller coupled to the transfer switch and configured to control the transfer switch to selectively couple one of the input and the inverter to the output, a network interface coupled to the first controller and configured to communicate with the computing device via the network and to communicate with the first controller to transfer data between the first controller and the computing device and to provide commands from the computing device to the first controller, and a housing containing the input, the output, the DC voltage source, the inverter, the transfer switch, the first controller, and the network interface, the housing including a chassis that is configured to be mounted to a wall and to support the UPS when mounted to a vertical wall.

Implementations of the invention may include one or more of the following features. The chassis includes a base configured to selectively couple to a fastener connected to the wall, a material and a thickness of the base being adapted to support a weight of the UPS when the UPS is mounted to the wall. The base is configured to support the UPS while coupled to only one fastener attached to the wall through a mounting arrangement of the base. The mounting arrangement comprises a portion of the base defining an aperture shaped to receive and to retain the fastener.

Implementations of the invention may also include one or more of the following features. The UPS further includes: a second controller coupled to the first controller and the network interface and configured to communicate with the first controller in a first controller in a first protocol and to communicate with the network interface in a second protocol different from the first protocol, and a reset device coupled to the second controller and configured to actuate a reset line of the second controller in response to be pressed. The housing provides a reset-device aperture that allows limited access to the reset device to inhibit accidental pressing of the reset device. The output includes at least one switched power outlet and wherein the first controller is configured to perform firmware instructions to process commands received by the network interface to control the at least one switched power outlet. The output includes four switched power outlets and wherein the firmware instructions are configured in one of two arrangements, in the first arrangement the firmware instructions are configured to instruct the first controller to control power to a first of the outlets, a second of the outlets, or a pair of the switched power outlets depending upon a received command and to control the power by turning power off, turning power on, or cycling power depending upon the received command, and in the second arrangement the firmware instructions are configured to instruct the first controller to control power to a first set of two of the outlets, a second set of two of the outlets, or all four of the switched power outlets depending upon the received command and to control the power by turning power off, turning power on, or cycling power depending upon the received command.

In general, in an aspect, the invention provides an uninterruptible power supply (UPS) for providing AC power to a load in a local area network, the local area network including at least one computing device, the UPS including an input configured to receive an AC power connector and to receive AC power through the AC power connector, an output configured to couple to another AC power connector and to provide AC power to the load through the another AC power connector, a DC voltage source configured to provide DC power, the DC voltage source including an energy storage device, an inverter coupled to the DC voltage source and configured to receive DC power from the DC voltage source and to convert the received DC power to AC power, a transfer switch coupled to the input and to the inverter and configured to selectively couple one of the input and the inverter to the output to provide AC power to the output, a first controller coupled to the transfer switch and configured to control the transfer switch to selectively couple one of the input and the inverter to the output, a network interface coupled to the first controller and configured to communicate with the computing device via the network and to communicate with the first controller to transfer data between the first controller and the computing device and to provide commands from the computing device to the first controller, the network interface including a web address to uniquely identify the UPS in the local area network, and means for mounting the UPS to a wall and supporting the UPS when mounted to a vertical wall, where the output includes at least one switched power outlet and wherein the first controller is configured to perform firmware instructions to process commands received by the network interface to control the at least one switched power outlet.

Implementations of the invention may include one or more of the following features. The mounting means includes a base configured to selectively couple to a fastener connected to the wall, a material and a thickness of the base being adapted to support a weight of the UPS when the UPS is mounted to the wall. The base is configured to support the UPS while coupled to only one fastener attached to the wall through a mounting arrangement of the base. The mounting arrangement comprises a portion of the base defining an aperture shaped to receive and to retain the fastener.

Implementations of the invention may also include one or more of the following features. The output includes a plurality of switched power outlets and wherein the firmware instructions are configured to instruct the first controller to control power to at least two of the outlets by turning power off, turning power on, or cycling power depending upon the received command. The output includes four switched power outlets and wherein the firmware instructions are configured in one of two arrangements, in the first arrangement the firmware instructions are configured to instruct the first controller to control power to a first of the outlets, a second of the outlets, or a pair of the switched power outlets depending upon a received command and to control the power by turning power off, turning power on, or cycling power depending upon the received command, and in the second arrangement the firmware instructions are configured to instruct the first controller to control power to a first set of two of the outlets, a second set of two of the outlets, or all four of the switched power outlets depending upon the received command and to control the power by turning power off, turning power on, or cycling power depending upon the received command.

Implementations of the invention may also include one or more of the following features. The network interface is configured to provide HTML interface pages to the computing device to provide a user of the computing device with information regarding the UPS and to prompt the user to enter commands for the first controller. The UPS further includes: a second controller coupled to the first controller and the network interface and configured to communicate with the first controller in a first controller in a first protocol and to communicate with the network interface in a second protocol different from the first protocol, and a reset device coupled to the second controller and configured to actuate a reset line of the second controller in response to be pressed. The mounting means comprises a housing that provides a reset-device aperture that allows limited access to the reset device to inhibit accidental pressing of the reset device.

In general, in an aspect, the invention provides a computer program product for discovering an uninterruptible power supply (UPS) connected to a network, the computer program product for use with a computer connected to the network, the computer program product residing on a computer readable medium and including computer-readable, computer-executable instructions for causing the computer to send a discovery message to the network with a destination address such that the discovery message will be broadcast to multiple UPSs connected to the network, to analyze a responsive communication from a responding UPS, the responsive communication providing a MAC address associated with the UPS, and to send an IP address-setting message to the network addressed to the responding UPS, the IP address-setting message including a designated IP address to be used by the responding UPS.

Implementations of the invention may include one or more of the following features. An IP address included in a payload of the IP address-setting message is configured to cause the responding UPS to delete a static IP address being used by the responding UPS, if any. The instructions for causing the computer to send the discovery message cause the computer to send the discovery message periodically. The instructions for causing the computer to send the discovery message cause the computer to send the discovery message approximately every five seconds. The designated IP address is configured to cause the UPS to turn on DHCP if DHCP is off. The computer program product further includes instructions for causing the computer to update a device list with device information contained in the responsive communication that is different than information stored by the computer. The computer program product further includes instructions for causing the computer to update a status indication associated with the responding UPS in accordance with status information contained in the responsive communication and to cause the computer to display indicia of the status of the responding UPS.

Various aspects of the invention may provide one or more of the following capabilities. Individual or ganged UPS outlets can be controlled remotely. Network equipment can be remotely reset or powered down. Networks can be remotely secured against outside communications. One or more home computers user can remotely monitor and control UPS usage and/or remotely cycle power to powered devices such as hubs, routers, and modems. A UPS can be unobtrusively placed in a home or business, e.g., in locations not designed or intended to accommodate such devices. A low-profile and/or relatively lightweight and/or wall-mountable UPS can be provided.

These and other capabilities of the invention, along with the invention itself, will be more fully understood after a review of the following figures, detailed description, and claims.

### BRIEF DESCRIPTION OF THE FIGURES

FIG. 1 is a simplified diagram of a communication network and a UPS connected to the network.

FIG. 2 is a front perspective view of the UPS shown in FIG. 1.

FIG. 3 is a side perspective view of the UPS shown in FIG. 1.

FIG. 4 is a bottom perspective view of the UPS shown in FIG. 1.

FIG. 5 is a top perspective view of the UPS shown in FIG. 1 with a cover of the UPS removed.

FIG. 6 is a top perspective view of the UPS shown in FIG. 1 with a cover of the UPS attached.

FIG. 7 is a simplified block diagram of the UPS shown in FIG. 1.

FIGS. 8-11 are exemplary screen shots of web pages displayed on a computer connected to the network as shown in FIG. 1.

FIG. 12 is a block flow diagram of a process of setting up the system shown in FIG. 1.

FIG. 13 is a block flow diagram of monitoring and controlling the UPS shown in FIG. 1.

### DETAILED DESCRIPTION OF PREFERRED EMBODIMENTS

Embodiments of the invention provide techniques for remotely monitoring and/or controlling UPSs through a communication network. A slave microcontroller of a UPS can communicate using HTML with a computer over an Ethernet communication network. Data can be provided to the computer regarding status of the UPS and commands from the computer can be received and provided to another, master, microprocessor. The master microprocessor can implement the commands to control the UPS as desired. The master also monitors the UPS to provide data regarding the status of the UPS to the slave microprocessor for transfer to the computer. Various controls are available to a user of the computer including selectively cycling the power at various power outputs of the UPS, either individually or multiple outlets concurrently. Other embodiments are within the scope of the invention.

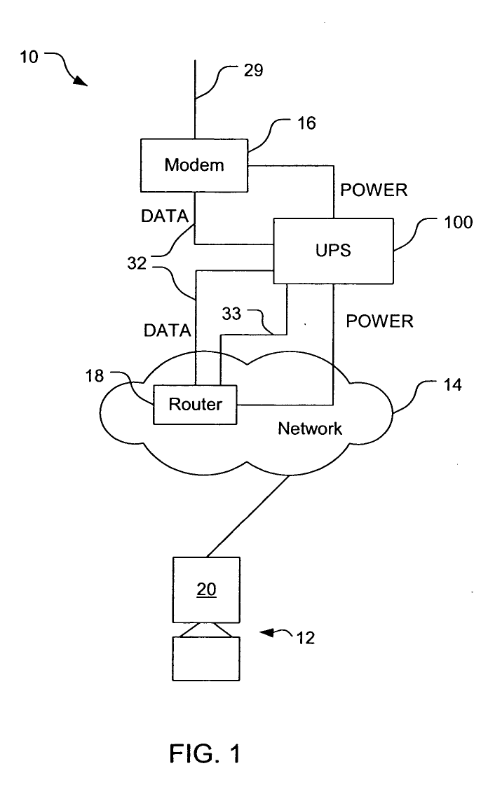

Referring to FIG. 1, an uninterruptible power supply (UPS) monitoring and control system 10 comprises a computer 12, a communication network 14, a UPS 100, and UPS-supported equipment including a modem 16 and a router (or switch or hub) 18. The network 14 is preferably a packet-switched network such as an Ethernet local area network (LAN), although other networks would be acceptable. The UPS 100 is configured to communicate with the computer 12 via the network 14 directly or through the router 18. Thus, in the discussion below, reference to communication between the UPS 100 and the computer 12 may be through the router 18 although the router 18 may not be specifically mentioned. As shown in FIG. 1, a cable 29 (e.g., a coaxial cable) for data communication to an external network such as the Internet is connected to the modem 16 (e.g., a cable modem). An Ethernet line 32 connects the modem 16 with the router 18, possibly passing through surge protection circuitry in the UPS 100. A line 33 connects the router 18 and the UPS 100 for transferring communications, e.g., commands, from the router 18 to the UPS 100. The router 18 is further coupled to the computer 12 and the UPS 100 through Ethernet lines of the network 14. The UPS 100 is configured to provide backup power to the equipment 16, 18 and to provide information regarding use of the backup power via the network 14 to the computer 12. The computer 12 includes a display screen 20 for displaying an interface to show the information regarding use of the backup power provided by the UPS 100 to a user 13 of the computer 12.

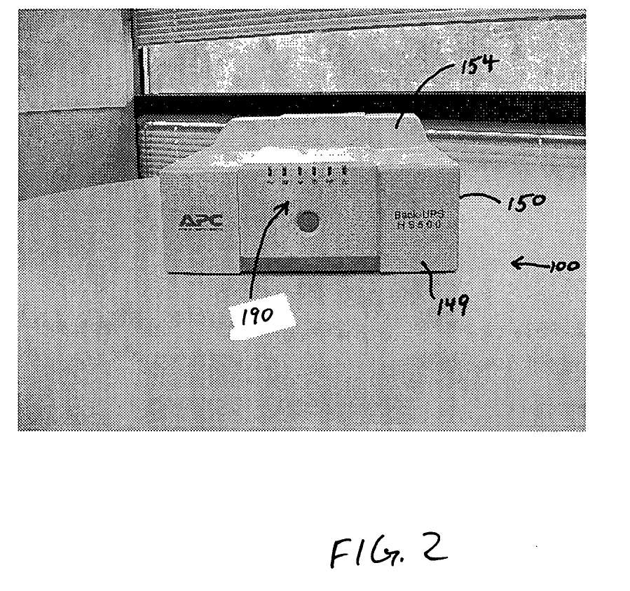

Referring to FIGS. 2-5 the UPS 100 includes a housing 150 that is configured to contain circuitry depicted below and to provide an unobtrusive, low profile. The housing 150 is sized and shaped such that the UPS 100 does not significantly extend away from a wall to which the housing 150 is mounted such that the UPS 100 may be placed in a variety of locations without requiring modifications of the location, e.g., of the wall, or other accommodations to permit the UPS's presence. The housing 150 provides for a low-profile UPS 100, e.g., with the housing having dimensions of about 14″ by about 8.5″ by about 4″ on one end and about 3″ on the other end. Thus, the housing 150 has a length/height aspect ratio of over 3:1 and a width/height aspect ratio of over 2:1.

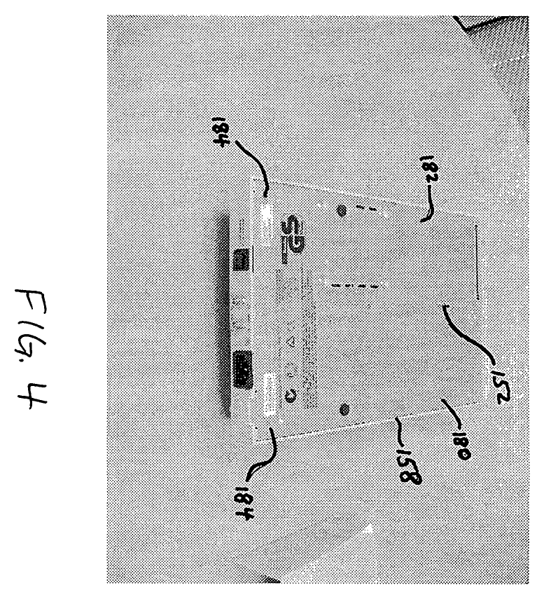

In addition to being configured to be rested on a horizontal surface, the housing 150 is configured to be wall-mounted in a home or small business, possibly in a location that was not expected or designed to have such equipment mounted to the wall. For example, the housing 150 may be mounted near an electrical circuit-breaker box, in a closet, etc. without substantially affecting the usefulness of the location in which the UPS 100 is mounted (e.g., the capacity of a closet). The housing 150 includes a metal chassis 180 including a metal bottom plate 182. The chassis 180 includes structures (not shown) for supporting circuitry internal to the UPS 100. The chassis 180 is made of a material, e.g., steel, that will support the UPS 100 when mounted to a vertical wall and preferably provide fire protection. Other materials, including plastic, could be used for the chassis 180. The bottom plate provides a hanging aperture 152 (FIG. 4) for receiving an appropriate attaching device such as a screw. The aperture 152 is located at the horizontal center of gravity and is a circular hole with a slot extending away from the center of the hole toward a front 186 of the housing (which is the top of the housing 150 when mounted to a vertical wall). The UPS 100 also includes two holes 184 that extend through the housing 150 including the bottom plate 182. Fasteners such as drywall screws can be inserted through the holes 184. Preferably, the UPS 100 is of a weight, e.g., less than about 20 pounds such that the UPS 100 can be mounted to a wall indefinitely, preferably without having to put the screws into a stud in the wall.

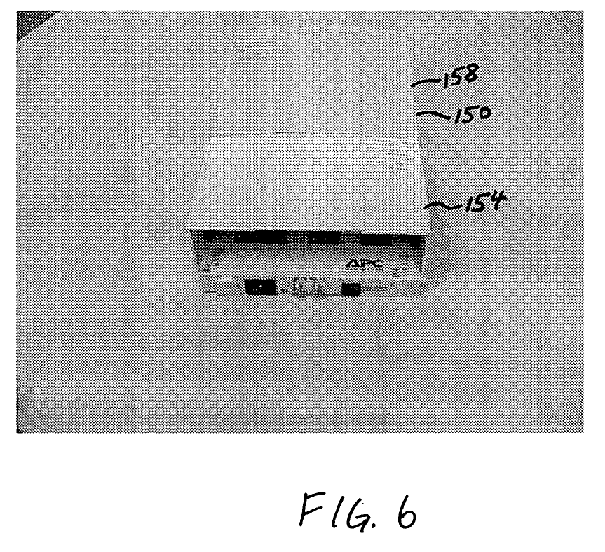

As shown, the housing 150 has a non-uniform, stepped height. A cover 154 of the housing 150 provides a sloped step 156. The cover 154 is removably attached to a base 158 of the housing 152. When attached to the base 158, the cover 154 shields and protects RJ-45 sockets and power output sockets (described below), and cables connected to these RJ-45 and power sockets. The cover 154 helps protect the sockets and connected cables, e.g., from dirt, accidental movement of the cables (that could disconnect them from the respective sockets), etc. The cover 154 is open on its end (FIG. 6) to allow and direct cables attached to the sockets to extend downward from the housing 150 (the cover 154 being toward the bottom of the housing 150) with the housing 150 mounted to a wall. With the cover 154 in place, the UPS 100 shown has a substantially rectangular, box shape that is compact, tidy, extends from the wall less than if a cover is not used to direct the cables downward, and is aesthetically pleasing.

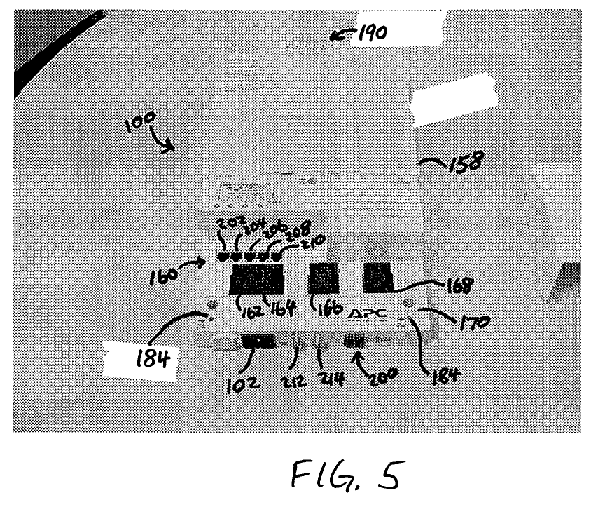

Referring especially to FIGS. 2 and 5, the UPS 100 includes status indicator lights 190. The lights 190 provide visual indications of the status of the UPS 100, including whether the UPS 100 is on-line, on battery power, is in need of battery replacement, is currently overloaded, is experiencing a processor communication fault, and is communicating with the host computer 14. The indicators 190 are visible from the top (FIG. 2) and from the side (FIG. 5) (that would be the top and side with the UPS 100 mounted to a vertical wall). The low battery indicator illuminates if battery voltage drops below about 10.5V with no load or about 9.5V with nominal load, typically when there is about two minutes of runtime remaining. The overload indicatory illuminates if the UPS 110 has supported a load of 125% nominal load for greater than four seconds, although other criteria could be used. A site wiring fault indicator 157 is configured to illuminate if the UPS 100 is not connected to ground.

As shown in FIG. 5, the UPS 100 includes an AC input 102, several, here five, RJ-45 jacks 160 and several, here four, female output power sockets 162, 164, 166, 168 provided in/on a ledge 170 that is disposed under the cover 154 (when the cover 154 is attached to the base 158). The sockets 162, 164, 166, 168 are configured to provide power to desired devices such as a router, a hub, a modem (such as a cable modem), etc. The sockets 162, 164, 166, 168 are directed upward with the UPS 100 resting on a horizontal surface and horizontally/outward with the UPS 100 mounted to a wall to help prevent power cables connected to the sockets 162, 164, 166, 168 from falling out of the sockets 162, 164, 166, 168, e.g., due to gravity. As discussed below, these output sockets 162, 164, 166, 168 can have their power controlled remotely via commands from the computer 12. The commands can be received, and other communications with the computer 12 conducted, through the RJ-45 sockets 160. A circuit breaker 200 protects the sockets 162, 164, 166, 168, e.g., from shorts downstream and can be reset after being tripped (preferably after curing the downstream cause of the trip). The jacks 160 include a jack 202 for connection to the router 16 or host computer 12, and two sets of pass-through jacks 204, 206 and 208, 210. The pass-through ports 204, 206 are connected to each other through surge protection circuitry for the network 14. The pass-through ports 208, 210 are connected to each other through surge protection circuitry for telephone or DSL lines. Coaxial connectors 212, 214 are connected to each other through surge protection circuitry in the UPS 100 to provide surge protection for the data line 29 connecting the network 14 to an external network. The UPS 100 can receive AC power through the AC input 102.

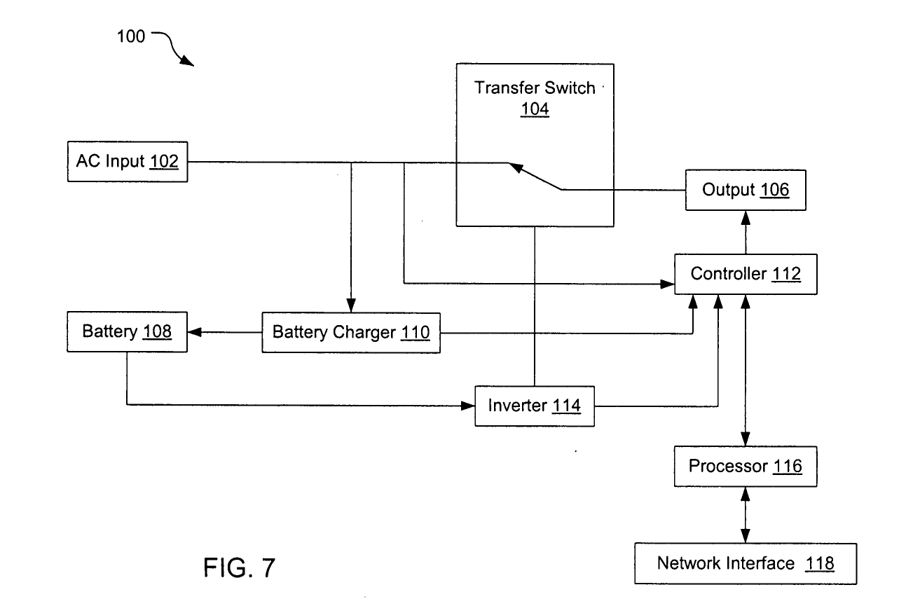

Referring to FIG. 7, with further reference to FIG. 1, the UPS 100 includes an AC input 102, a transfer switch 104, an output 106, a battery 108, a controller 112, and an inverter 114. The UPS 100 can include a battery charger 110, but need not. The AC input 102 is configured to couple to an AC power source and the output 106 is configured to couple to a load. The input 102 provides power received from the AC source to the transfer switch 104 and to the battery charger 110. The transfer switch 104 receives AC power from the input 102 or from the inverter 114. The inverter 114 receives DC power from the battery 108 and converts the DC power to AC power and provides the AC power to the transfer switch 104. The controller 112 determines whether power is to be provided from the AC input 102 or from the inverter 114 in accordance with allowable tolerances of the system 100. Depending on the capacity of the battery 108 and the power requirements of the load, the UPS 100 can provide power to the load during brief AC power source “dropouts” or for extended power outages. The UPS 100 is exemplary only and not limiting as other UPS configurations can be used with embodiments of the invention.

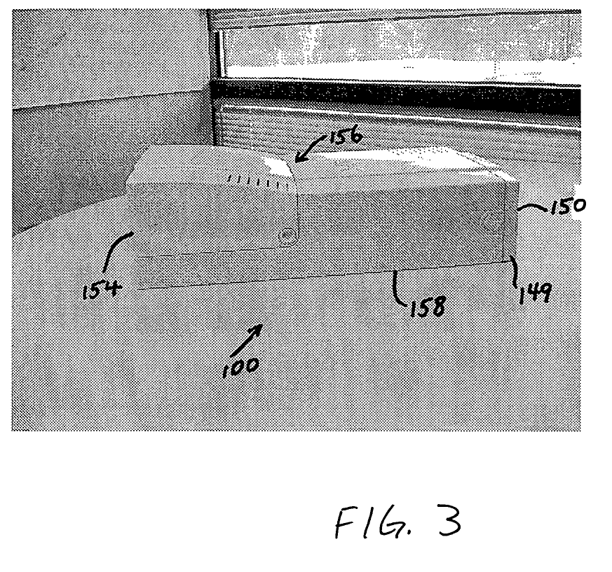

The UPS 100 further includes a microprocessor 116 and a network interface 118. The processor 116 may be referred to as a slave processor, or simply a slave, and the controller 112, that includes a microprocessor, may be referred to as a master processor, or simply a master. The master 112 is configured to monitor data regarding status parameters of the UPS 100 and to implement control commands to control operation of the UPS 100. The slave 116 is configured to relay information between the network interface 118 and the master processor 112. The master 112 and the slave 116 preferably operate without software, instead executing instructions in firmware. The slave 116 preferably can communicate with the master 112 at a rapid rate such as 9600 baud. If communication between the master 112 and the slave 116 fail, then a communication fault indicator 190 (FIG. 5) is actuated. To rectify this situation, the slave processor 116 can be reset by actuating its reset line. To do this, a cover 149 (FIGS. 2-3) of the housing 150 that provides access to the battery 108 can be removed and a reset button pressed (e.g., by inserting a thin rod such as a pin through a pin hole that provides access to the reset button).

The slave processor 116 includes embedded Ethernet capability. The slave 116 is, e.g., a Microchip processor model 18F452 made by Microchip Technology Incorporated of Chandler, Ark. Using embedded Ethernet circuitry helps control the cost of the UPS 100, e.g., to make the UPS 100 desirable for home or small business use.

The master microprocessor 112 is configured to control various aspects of the UPS 100 independently or in accordance with instructions received from the slave 116 from the computer 12. The controller 112 is configured to determine when battery power is needed and to control the transfer switch 104 to provide power to the output 106 from either the AC input 102 and/or the battery 108, via the inverter 114, as appropriate. The processor 22 is configured to perform its various functions by reading and executing computer-readable, computer-executable software instructions 34 stored in the memory 32. The master 112 can further receive commands/instructions from the computer 12 via the network 14, the interface 118, and the slave 116 and control portions of the UPS 100 to implement the commands. For example, the master 112 can cycle the power of desired sockets of the output 106. For example, the master 112 can cause one set of the sockets (e.g., the sockets 162, 164) or another set (e.g., the sockets 166, 168) to have their power cycled, that is to power the sockets down and then to power the sockets back up after a delay, e.g., of about 15 seconds. Thus, the master 112 can selectively power down, e.g., a cable modem powered by the UPS 100 and power the modem back up to thereby reset the modem. The master 112 can also concurrently cycle power all of the sockets 162, 164, 166, 168 in a ganged arrangement. Further, the master 112 is configured to limit access to the UPS 100 controls or data by the user 13, e.g., by requiring a user name and password before permitting such access.

The master 112 is configured to monitor a wide range of parameters regarding the UPS 100. For example, the master 112 can monitor the power use/availability of the UPS 100, including power available from the input 102 or the battery 108. The master 112 can monitor whether the battery 108 is idle, discharging, or charging, whether power is currently being supplied by the AC input 102 or the battery 108, what the current load on the battery 108 is (e.g., in watts), a communication fault condition between the processors 112, 116, voltage level(s) and/or frequency(ies) at the input 102, whether the battery 108 is present, etc. The master 112 can also log in memory various information regarding the UPS 100 such as current range of acceptable AC voltage at the input 102, date of last replacement of the battery 108, what the cause of the most recent transfer to battery power was, etc.

The master microprocessor 112 is configured to manipulate monitored data, e.g., to provide the monitored data in formats that are relevant to and/or desired by the user 13. For example, the master 112 can calculate the percentage of battery capacity remaining (e.g., percentage of energy remaining). The master can also determine, given the remaining battery capacity and the current load, the time until shutdown of the UPS 100. This time may be provided in discrete increments such as to the minute, rounded to the nearest 5 minutes, or 10 minutes, etc., or to the next lower range (e.g., 5 minutes, 10 minutes, etc.), or combinations of these (e.g., nearest 5 minutes until under 5 minutes, and then to the minute), etc. The master 112 can also determine, and provide appropriate indications, that the battery is currently overloading (e.g., of the load exceeds an overload threshold, e.g., 110%, of recommended maximum load), low (e.g., if the capacity drops below a low threshold, e.g., 20% of recommended maximum capacity), or in need of replacement (e.g., if capacity drops below a replace threshold, e.g., 10% of recommended max capacity).

The master 112 is configured to provide monitored data, that may have been manipulated, to the slave 116 for transfer to the computer 12. The master 112 and slave 116 communicate with each other using a protocol that is different from the protocol used for communications between the UPS 100 and the computer 12. The master 112 and the slave 116 communicate using an appropriate protocol through an optical boundary such to provide for grounded communication between the slave 116 and the router 16.

The network interface 118 (e.g., a network interface card or an equivalent apparatus) is embedded in the UPS 100 and is configured to process data received from the slave 116 for transfer to the computer 12, and to process data received from the computer 12 for transfer to the slave 116. The slave 116 runs a TCP/IP stack supporting HTML and communicates with the network interface to provide data and to receive data and instructions. The interface 118 includes a CAT5 output connector configured to connect to a CAT5 (USB) line connecting the UPS 100 to the computer 12, e.g., for Ethernet communications. To exchange data and instructions with the computer 12, the network interface 118 is configured to communicate with the computer 12 using an HTTP over TCP/IP protocol. A web report descriptor is produced by the slave 116 that defines the interface between the UPS 100 and the computer 12. This report preferably contains separate descriptors are preferably used for static data, dynamic data (e.g., read-only values such as remaining battery capacity), and controllable data. The report also preferably contains a usage tag (or data item identifier) that is a unique number and whose absence or presence informs the computer 12 of the availability of data items from the UPS 100. The computer 12 will retrieve the report, preferably once, during enumeration, which is the process of discovering the presence of a web-enabled device on the network and reading out the descriptor in order to determine the device's capabilities. A link light of the status indicators 190 (FIG. 5) flashes to indicate activity between the UPS 100 and the computer 14 (or at least the router 16). If this indicator is off, then there is no such activity (not even heartbeat communication), indicating lack of communication between the UPS 100 and the router 16 or computer 14.

Communications between the UPS 100, specifically the network interface 118, and the computer 12 are preferably through user-friendly web pages in a format for easy consumption by the user 13. The network interface 118 is configured to communicate the monitored data in the user-friendly format(s) to the user computer 12, and to receive commands and indications of desired data from the computer 12, as indicated by selections in the web pages, via the communication network 14.

The UPS 100 and the computer 12 are configured to communicate with each other through the network 14 for the host 12 to find the UPS 100 and to establish a network address for the UPS 100 through a series of messages (e.g., UDP packets). The UPS 100 is DHCP (dynamic host configuration protocol) client and supports an IP gleaning implementation for assigning a static IP address to the UPS 100. The UPS 100 is configured to respond to discover messages from the host computer 12 to establish an IP address for the UPS 100 for use in the network 14. The host 12 includes software code instructions (that may be provided, e.g., on a disk, with the UPS 100 and loaded onto the host 12) for sending messages to discover the UPS 100, parse responses from the UPS 100, and update addressing information for the UPS 100.

The host 12 is configured to send a UPS Discover communication into the network 14 for locating compatible UPSs. The UPS Discover message includes a source IP address for the host 12, a source port number, a destination IP address, and a destination port number. The destination IP address is set so that the UPS Discover message is broadcast to multiple, preferably all, devices connected to the network 14. The host 12 is configured to send the UPS Discover message every 5 seconds.

The UPS 100 is configured to respond to the UPS Discover communication with a UPS Response message. The UPS Response message includes a source IP address, a source port number, a destination IP address, and a destination port number. The source IP addess is the IP of the UPS 100 if the UPS 100 is configured and is 0.0.0.0 if the UPS 100 is un-configured. The source port number in the UPS Response is the same as the destination port number in the UPS Discover message, and vice versa. If the UPS 100 is un-configured, then the destination IP address will broadcast the message to the network 14. If the UPS 100 has an IP address, then the destination address is the source IP address from the UPS Discover message.

The payload of the UPS Response message includes an ISX device type, a label string, a serial number of the UPS 100, a MAC address of the network interface 1118, a UPS status indication, an HTTP port, a device name, and a DHCP support value. The UPS status indication can indicate that the UPS 100 does not support reporting of the status, or can indicate normal, warning, or severe conditions of the UPS 100. If the UPS 100 supports an HTTP interface and it is enabled, then the HTTP port is the port number of the interface and is empty otherwise. The device name is a character string (e.g., up to 12 ASCII characters) for identifying the UPS 100. The DHCP support value preferably has one of two values, e.g., 0 or 1. If the value is 0, then the UPS 100 is not actively looking for a DHCP address (the DHCP support is currently not active). If the value is 1, then the UPS is un-configured, or it currently has an IP address that was assigned by a DHCP server. This value indicates that the DHCP support is currently active. The ISX device type and label string are used to determine if the UPS Response is a valid response and that the source of the information is a UPS of the type (e.g., make and model) of the UPS 100.

The host 12 is configured to parse the UPS Response packet to extract information about each UPS that responds, and to show at least some of this information on the display 20. The host 12 checks the MAC address against the information that the host 12 currently has on record to determine if this information is from a new UPS, or if the information that the host 12 has on a particular UPS has changed. New or changed UPS information is reflected by the host 12 updating a device list, e.g., shown on the display 20.

The host 12 is further configured to send a UPS Set IP message to the UPS 100 in response to the UPS Response message. The UPS Set IP message is sent if a new IP address is desired for a UPS with a currently-existing IP address (e.g., if a device is added to the network 14 whose IP address conflicts with the UPS' IP address), or to establish an IP address for a UPS without a currently-existing IP address. The host 12 supports IP gleaning to assign an IP address to an un-configured UPS. The host 12 can insert an IP address to be assigned to the UPS 100 into an ARP (address resolution protocol) cache as a new static IP address. The host 12 will send the UPS Set IP message to this IP address, and then remove the static ARP entry from the ARP cache. Further queries to the UPS 100 with the UPS Discover message will result in the host 12 being informed of the UPS's new IP address.

The UPS Set IP message includes a source IP address, a source port, a destination IP address, a destination port, and a payload. The source IP address is the IP address of the outgoing interface on the host 12. The source port is an ephemeral port number assigned at the time the message is sent. The destination IP address is the IP address of the UPS whose IP address is being sent, e.g., the UPS 100. This destination IP address is preferably sent to a unicast IP address, and preferably not sent to a broadcast address. The destination port number is the same as for the UPS Discover communication. The payload of the UPS Set IP message represents the IP address to be set for the UPS 100. For example, the payload can have four bytes of hexadecimal data representing the IP address to be set. An IP address is 0 (i.e., 0.0.0.0), causes the UPS 100 to turn on its DHCP, if the DHCP is currently inactive, and to delete any static IP address currently used by the UPS 100. If the UPS 100 is already configured to DHCP, then in response to an IP address of 0, the UPS 100 may redo its DHCP configuration exchange (that typically results in the current IP address being kept). If the DHCP server is unavailable at the time, then the IP address is reset to 0.0.0.0 until such time as the DHCP server becomes available. The UPS 100 preferably supports APIPA (automatic private internet protocol addressing) as a backup to DHCP in case the DHCP server is unavailable.

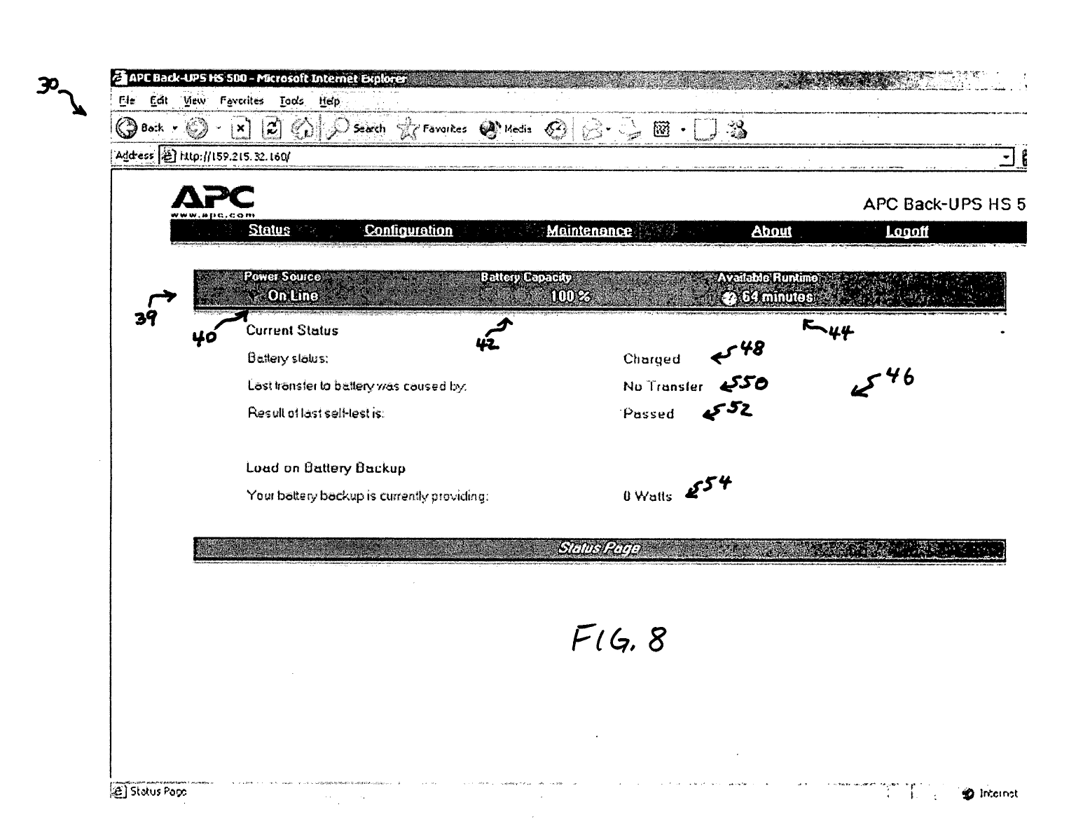

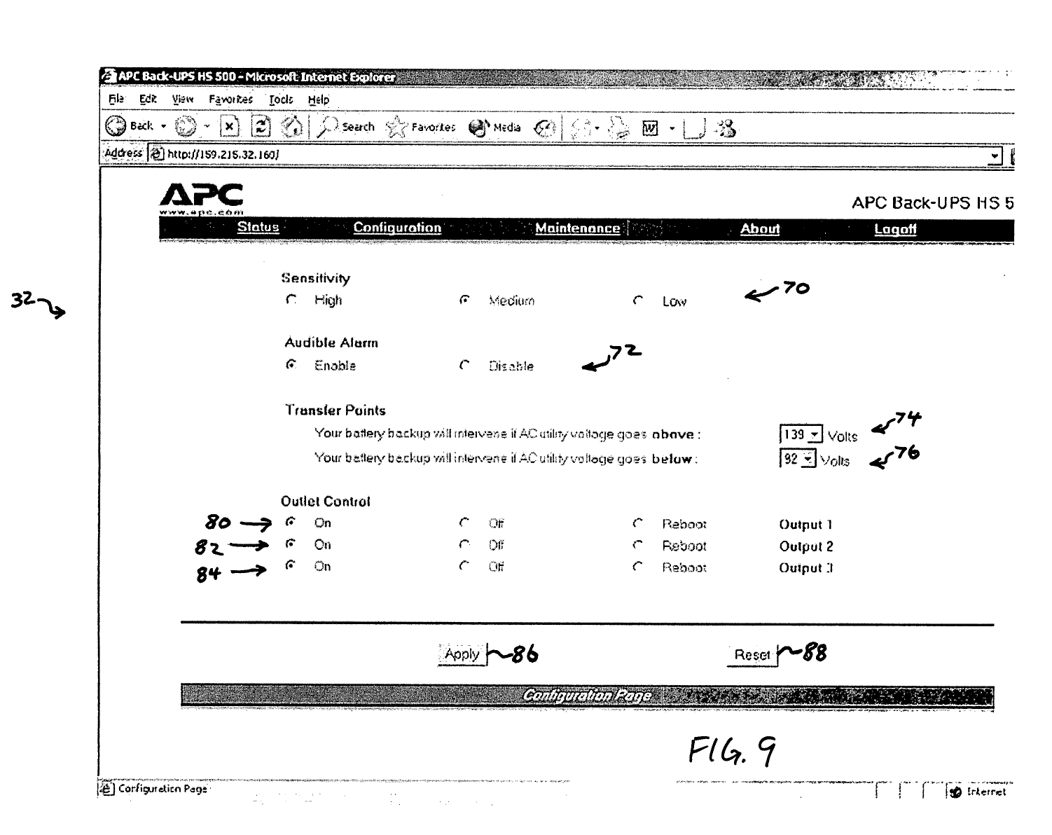

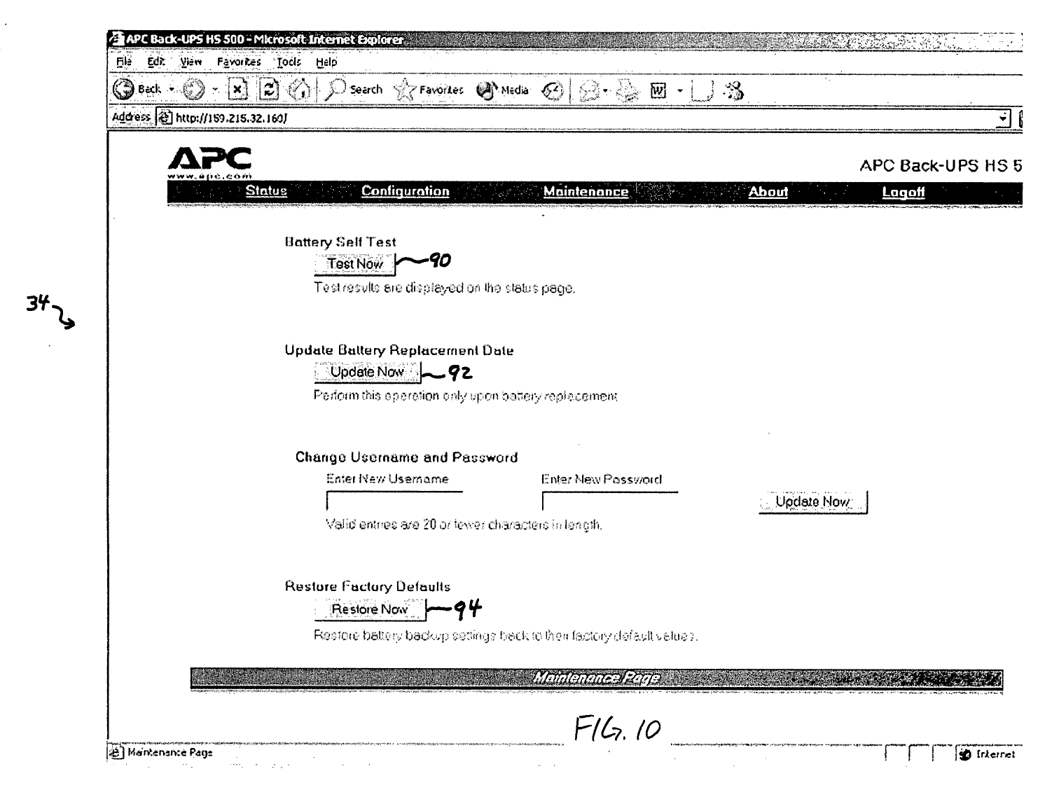

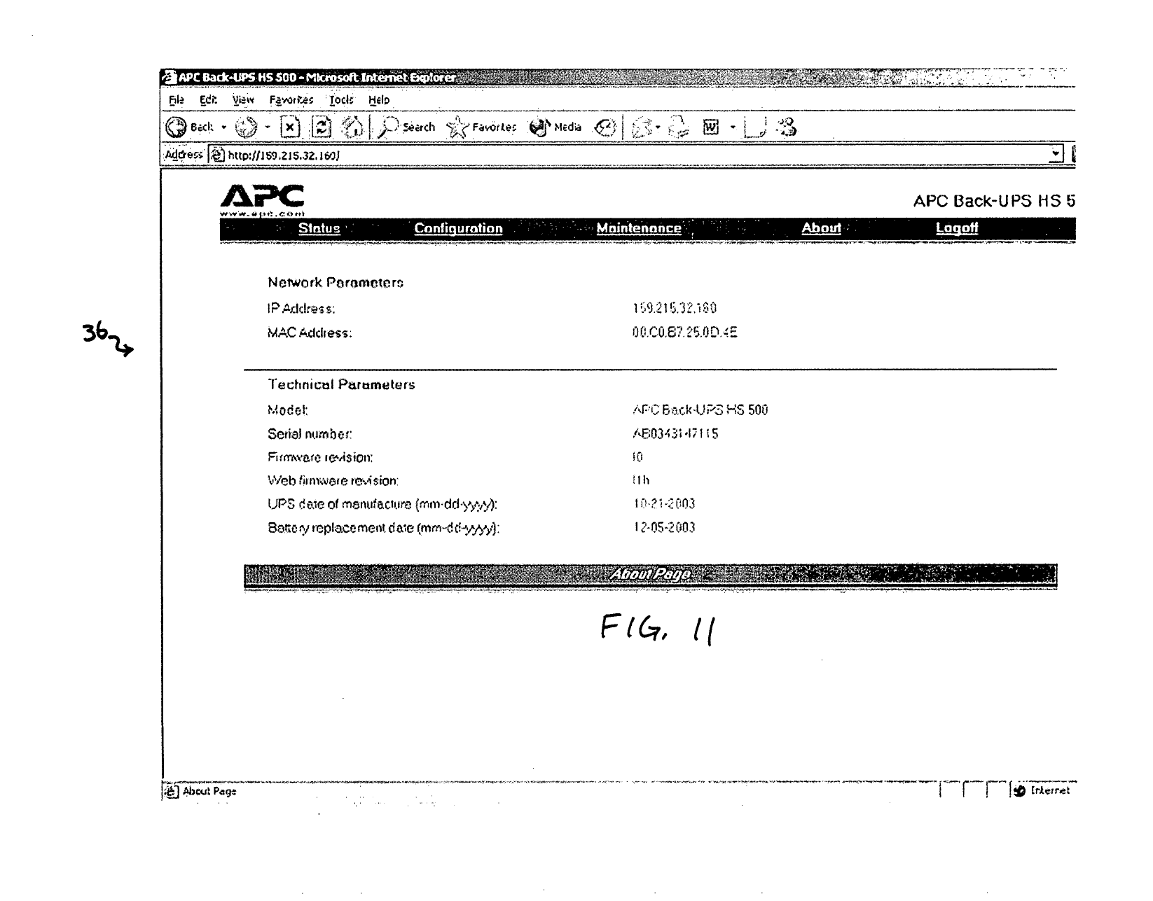

Referring also to FIGS. 8-11, status, configuration, maintenance, and specification web pages 30, 32, 34, 36 are provided by the interface 118 to the computer 12 for analysis by the user 13. A logon web page is also provided to prompt the user 13 to enter a username and password for security before permitting access to the web pages 30, 32, 34, 36 that provide information regarding the UPS 100 and allow the user 13 to control the UPS 100. The UPS 100 is configured to store all the data provided in the web pages 30, 32, 34, 36. The processor 112 is configured to execute instructions to provide data for the web pages regarding the UPS 110. The web browser of the computer 13 can access the web pages 30, 32, 34, 36 by accessing the UPS 100 using the UPS' IP address.

The status web page 32 shows the current status of battery 108 as reflected in various statistics. The web page 32 provides a quick-reference bar 39 that includes combined graphical/textual indications 40, 42, 44 of the current power source, battery capacity, and available runtime until shutdown of the UPS 100. The power source indicator 40 can indicate on line, with an AC plug icon and “on line” text, or can indicate battery power, with “battery” text and a battery icon that can be of different colors representing battery capacity. The battery indicator and may also include varying levels of colors (e.g., the bottom half of the icon being green and the top half being another color, e.g., brown, indicating that the battery 108 is at about half capacity).

Text status indicators are provided in a table 46. A battery-status indicator 54 indicates if the battery 108 is currently charged (as shown), charging, discharging, overloaded, low, or in need of replacement. A transfer indicator 50 shows whether there has been a transfer to battery and, if so, the reason for the most-recent transfer from AC input power to battery power. A self-test indicator 52 shows whether the UPS 100 passed or failed the most-recent self test performed (e.g., automatically or as commanded through the computer 12) by the master processor 112. A load indicator 54 shows the wattage currently being supplied by the battery 108.

The configuration web page 32 shows the current settings, either defaulted to by the UPS 100 or set by the user 13, for various parameters affecting the performance of the UPS 100. A sensitivity indicator 70 shows whether the current sensitivity (the degree to which the input voltage deviates from nominal before the UPS 100 intervenes) is low, medium, or high and allows the user 13 to select the desired sensitivity. An audible alarm indicator 72 shows whether the audible alarm for indicating battery backup in use is enabled or disabled and allows the user to change the setting. Upper and lower transfer-point indicators 74, 76 show the current setting of threshold voltage values at the AC input 102 defining an acceptable voltage range. If the voltage at the input 102 is within this range, then the transfer switch 104 will be set by the master 112 to provide power to the output 106 from the input 102. If the voltage at the input 102 is outside this range, then the transfer switch 104 will be set by the master 112 to provide power to the output 106 from the battery 108. The indicators 74, 76 allow the user to select other values for the upper and lower limits (e.g., limited to integers between 136 and 142 VAC for the upper limit and between 88 and 96 VAC for the lower limit). Three outlet control indicators 80, 82, 84 indicate the current status of three outputs. Output 1 corresponds to and controls output socket 162, output 2 corresponds to and controls output socket 164, and output 3 corresponds to and controls output sockets 166, 168. The user 13 can change the current settings for these outputs, or any of the other indicators shown, and command the UPS 100 to implement the new status (e.g., turn on, off, or cycle the power to (i.e., reboot) corresponding output sockets, change the sensitivity, etc.) by selecting an APPLY virtual button 86. Status indicators can be set to their previous (or default) positions by selecting a RESET virtual button 88.

The maintenance page 34 provides virtual buttons and windows for initiating various maintenance tasks. The user 13 can select a Test Now virtual button 90 to initiate a battery self test by the master processor 112, an Update Now button 92 to update the battery replacement date, or a Restore Now button 94 to reset setting to their factory default values. The user 13 may also provide a new password and select an Update Now button 96 to change the user's old password to the new password.

The specifications web page 36 shows information about the UPS 100. The specifications web page 36 further shows network parameters, here the IP and MAC addresses of the UPS 100. The page 36 further shows technical parameters, here the model, serial number, firmware revision, web firmware revision, date of manufacture, and date of last battery replacement of/for the UPS 100. The battery replacement date is alterable by the user 13 through the maintenance page 34. The user actuates the button 92 after replacing the battery 108, causing the replacement date to be changed in the UPS 100.

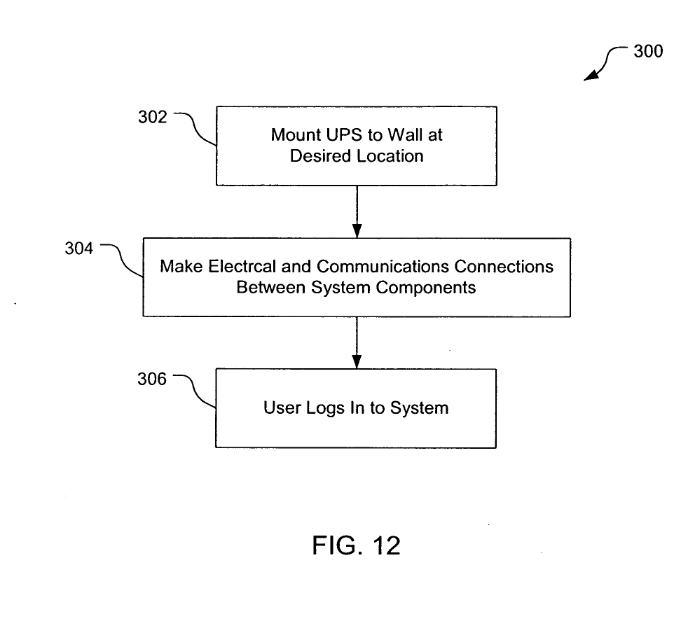

Referring to FIG. 12, with further reference to FIGS. 1-6, a process 300 for setting up the system 10 includes the stages shown. The process 300, however, is exemplary only and not limiting. The process 300 may be altered, e.g., by having stages added, removed, or rearranged.

At stage 302, the UPS 100 is mounted to a wall at a desired location, e.g., in the user's home. A screw is inserted into a wall and the housing 150 placed against the wall so that the circular portion of the aperture 152 receives the screw head. The housing 150 is moved such that the shaft of the screw slides to the end of the slot portion of the aperture 152 such that the shaft holds the UPS 100 up while the screw head retains the housing 150 against the wall. With the housing hanging on the screw in the aperture 152, a person inserts fasteners through the holes 184. For example, a person screws drywall screws through the holes 184. The person can insert fasteners through the holes 184 using both hands as the UPS 100 is supported by the screw received by the aperture 152.

At stage 304, electrical and communication connections between components of the system 10 are made. The cable 29 is connected to the connector 212 on the UPS 100 through surge protection circuitry to the connector 214 that is connected to the cable modem 16. The Ethernet line 32 is connected from the cable modem 16 to the jack 204 through surge suppression circuitry to the jack 206 to the router 18. The router 18 is connected with Ethernet lines to the computer 12 and to the host connection jack 202 for communication between the UPS 100 and the network 14. The communication line 32 is connected between the UPS 100 and the router 18. An AC power line is connected to the AC input 102 and power lines are connected to the sockets 162, 164, 166, 168 to desired equipment, preferably including the cable modem 16 and the router 18. A DSL or telephone line can be connected to the jack 208 through surge suppression circuitry to the jack 210 that can be connected to a desired device for receiving the line.

At stage 306, the user 13 logs in to the UPS 100. Software in the computer 12 is run to search the network 14 to find the UPS 100. The user 13 accesses a login page for the UPS 100 and enters a user name and password. If these are acceptable, the computer 12 is provided access to monitored information of the UPS 100 and allowed to control certain functions/parameters of the UPS 100.

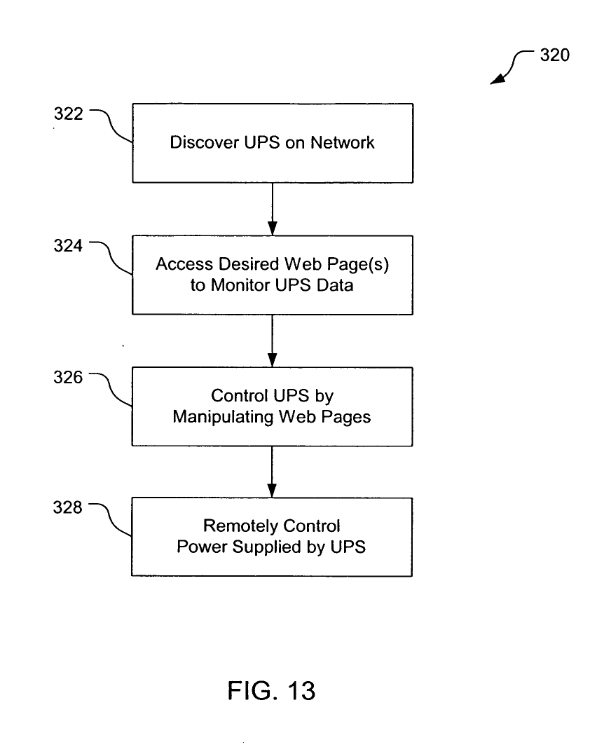

In operation, referring to FIG. 13, with further reference to FIGS. 1 and 7-11, a process 320 for monitoring and controlling operation of the UPS 100 through the computer 12, or directly, includes the stages shown. The process 320, however, is exemplary only and not limiting. The process 320 may be altered, e.g., by having stages added, removed, or rearranged.

At stage 322, the host 12 and the UPS 100 communicate so that the host 12 discovers, and assigns an IP address to, the UPS 100. The host 12 sends a UPS Discover communication to the network 14 that broadcasts the message to all devices connected to the network 14. The UPS 100 receives the UPS Discover message and replies with a UPS Response communication that provides the MAC address of the interface 118 and possibly status of the UPS 100. The host 12 parses the UPS Response, updates new or changed information in the device list stored by the host 12 and shown on the display 20. If a UPS Set IP message is in order, then the host 12 sends the UPS Set IP message, including the IP address for the UPS 100.

At stage 324, the user 13 accesses the UPS 100 using the computer 12 to receive UPS information, e.g., regarding power supplied by the UPS 100, and/or to provide commands to the UPS 100. After logging in, the user 13 operates a web browser of the computer 12 to access, as desired, the web pages 30, 32, 34, 36 provided by the UPS 100 for accessing UPS information. The user 13 can switch between any of the pages 30, 32, 34, 36 by selecting the appropriate link on the currently-displayed page.

At stage 326, the user can control the UPS 100 by manipulating/interacting with the various web pages 30, 32, 34, 36. The user 13 can issue commands to control/alter a wide range of parameters by selecting different values of available operational characteristics/parameters in the pages 30, 32, 34, 36. For example, while interacting with the configuration page 32 the user 13 can change the sensitivity, change whether the audible alarm is enabled, or adjust voltage transfer points. At the maintenance page 36 the user can, e.g., initiate a self-test of the UPS 100.

At stage 328, the user 13 remotely controls the power supplied by the UPS 100. Based on information received from the UPS 100 or from information acquired by the user 13, e.g., that the computer's Internet connection is failing, or that connectivity in the network 14 is failing, the user 13 may decide to power off, power on, or cycle power of, devices connected to the UPS 100. The user sends a command or commands to turn off, turn on, or cycle power of the desired sockets 162, 164, 166, 168 using the configuration page 32, selecting the appropriate value of the desired indicator 80, 82, 84, and actuating the Apply button 86. The command(s) is(are) implemented by the master processor 112 to affect the power at either the sockets 162, 164 or the sockets 166, 168, or all of the sockets 162, 164, 166, 168 of the UPS' output 106 in accordance with which actuator 80, 82, 84 was altered and how.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. Furthermore, while the description above focused on a UPS that is wall-mounted, the UPS need not be wall-mounted or wall-mountable. Also, the indicators 80, 82, 84 can control different output sockets than as described above, e.g., the indicator 80 could control sockets 162, 164, the indicator 82 could control the sockets 166, 168, and the indicator 84 could control all four of the sockets 162, 164, 166, 168.

The UPS 100 may be configured to mount to a wall differently than as described above. For example, the aperture 152 and the holes 184 may be provided integrated into a body of the housing 150 as shown, but may also be provided in numerous other ways such as in tabs or brackets extending from the body of the housing 160. Different shapes of apertures, such as circular holes (especially if provided in brackets extending from the body of the housing 150) may be used. Other quantities of apertures and/or holes may also be used. Also, other techniques for wall-mounting the housing may be used. For example, apertures may be provided in a separate fixture that can be mounted to the wall and to which the body of the housing can then be attached (e.g., with hook and loop fasteners, interfering tabs, sliding the housing onto the bracket, etc.).

1. An uninterruptible power supply (UPS) for providing AC power to a load in a local area network, the local area network including at least one computing device, the UPS comprising:
an input configured to receive an AC power connector and to receive AC power through the AC power connector;
an output configured to couple to another AC power connector and to provide AC power to the load through the another AC power connector;
a DC voltage source configured to provide DC power, the DC voltage source including an energy storage device;
an inverter coupled to the DC voltage source and configured to receive DC power from the DC voltage source and to convert the received DC power to AC power;
a transfer switch coupled to the input and to the inverter and configured to selectively couple one of the input and the inverter to the output to provide AC power to the output;
a first controller coupled to the transfer switch and configured to control the transfer switch to selectively couple one of the input and the inverter to the output;
a network interface coupled to the first controller and configured to communicate with the computing device via the network and to communicate with the first controller to transfer data between the first controller and the computing device and to provide commands from the computing device to the first controller; and
a housing containing the input, the output, the DC voltage source, the inverter, the transfer switch, the first controller, and the network interface, the housing including a chassis that is configured to be mounted to a wall and to support the UPS when mounted to a vertical wall.

2. The UPS of claim 1 wherein the chassis includes a base configured to selectively couple to a fastener connected to the wall, a material and a thickness of the base being adapted to support a weight of the UPS when the UPS is mounted to the wall.

3. The UPS of claim 2 wherein the base is configured to support the UPS while coupled to only one fastener attached to the wall through a mounting arrangement of the base.

4. The UPS of claim 3 wherein the mounting arrangement comprises a portion of the base defining an aperture shaped to receive and to retain the fastener.

5. The UPS of claim 1 further comprising:
a second controller coupled to the first controller and the network interface and configured to communicate with the first controller in a first controller in a first protocol and to communicate with the network interface in a second protocol different from the first protocol; and
a reset device coupled to the second controller and configured to actuate a reset line of the second controller in response to be pressed.

6. The UPS of claim 5 wherein the housing provides a reset-device aperture that allows limited access to the reset device to inhibit accidental pressing of the reset device.

7. The UPS of claim 1 wherein the output includes at least one switched power outlet and wherein the first controller is configured to perform firmware instructions to process commands received by the network interface to control the at least one switched power outlet.

8. The UPS of claim 7 wherein the output includes four switched power outlets and wherein the firmware instructions are configured in one of two arrangements, in the first arrangement the firmware instructions are configured to instruct the first controller to control power to a first of the outlets, a second of the outlets, or a pair of the switched power outlets depending upon a received command and to control the power by turning power off, turning power on, or cycling power depending upon the received command, and in the second arrangement the firmware instructions are configured to instruct the first controller to control power to a first set of two of the outlets, a second set of two of the outlets, or all four of the switched power outlets depending upon the received command and to control the power by turning power off, turning power on, or cycling power depending upon the received command.

9. An uninterruptible power supply (UPS) for providing AC power to a load in a local area network, the local area network including at least one computing device, the UPS comprising:
an input configured to receive an AC power connector and to receive AC power through the AC power connector;
an output configured to couple to another AC power connector and to provide AC power to the load through the another AC power connector;
a DC voltage source configured to provide DC power, the DC voltage source including an energy storage device;
an inverter coupled to the DC voltage source and configured to receive DC power from the DC voltage source and to convert the received DC power to AC power;
a transfer switch coupled to the input and to the inverter and configured to selectively couple one of the input and the inverter to the output to provide AC power to the output;
a first controller coupled to the transfer switch and configured to control the transfer switch to selectively couple one of the input and the inverter to the output;
a network interface coupled to the first controller and configured to communicate with the computing device via the network and to communicate with the first controller to transfer data between the first controller and the computing device and to provide commands from the computing device to the first controller, the network interface including a web address to uniquely identify the UPS in the local area network; and
means for mounting the UPS to a wall and supporting the UPS when mounted to a vertical wall;
wherein the output includes at least one switched power outlet and wherein the first controller is configured to perform firmware instructions to process commands received by the network interface to control the at least one switched power outlet.

10. The UPS of claim 9 wherein the mounting means includes a base configured to selectively couple to a fastener connected to the wall, a material and a thickness of the base being adapted to support a weight of the UPS when the UPS is mounted to the wall.

11. The UPS of claim 10 wherein the base is configured to support the UPS while coupled to only one fastener attached to the wall through a mounting arrangement of the base.

12. The UPS of claim 11 wherein the mounting arrangement comprises a portion of the base defining an aperture shaped to receive and to retain the fastener.

13. The UPS of claim 9 wherein the output includes a plurality of switched power outlets and wherein the firmware instructions are configured to instruct the first controller to control power to at least two of the outlets by turning power off, turning power on, or cycling power depending upon the received command.

14. The UPS of claim 13 wherein the output includes four switched power outlets and wherein the firmware instructions are configured in one of two arrangements, in the first arrangement the firmware instructions are configured to instruct the first controller to control power to a first of the outlets, a second of the outlets, or a pair of the switched power outlets depending upon a received command and to control the power by turning power off, turning power on, or cycling power depending upon the received command, and in the second arrangement the firmware instructions are configured to instruct the first controller to control power to a first set of two of the outlets, a second set of two of the outlets, or all four of the switched power outlets depending upon the received command and to control the power by turning power off, turning power on, or cycling power depending upon the received command.

15. The UPS of claim 9 wherein the network interface is configured to provide HTML interface pages to the computing device to provide a user of the computing device with information regarding the UPS and to prompt the user to enter commands for the first controller.

16. The UPS of claim 9 further comprising:
a second controller coupled to the first controller and the network interface and configured to communicate with the first controller in a first controller in a first protocol and to communicate with the network interface in a second protocol different from the first protocol; and
a reset device coupled to the second controller and configured to actuate a reset line of the second controller in response to be pressed.

17. The UPS of claim 16 wherein the mounting means comprises a housing that provides a reset-device aperture that allows limited access to the reset device to inhibit accidental pressing of the reset device.

18. A computer program product for discovering an uninterruptible power supply (UPS) connected to a network, the computer program product for use with a computer connected to the network, the computer program product residing on a computer readable medium and comprising computer-readable, computer-executable instructions for causing the computer to:
send a discovery message to the network with a destination address such that the discovery message will be broadcast to multiple UPSs connected to the network;
analyze a responsive communication from a responding UPS, the responsive communication providing a MAC address associated with the UPS; and
send an IP address-setting message to the network addressed to the responding UPS, the IP address-setting message including a designated IP address to be used by the responding UPS.

19. The computer program product of claim 18 wherein an IP address included in a payload of the IP address-setting message is configured to cause the responding UPS to delete a static IP address being used by the responding UPS, if any.

20. The computer program product of claim 18 wherein the instructions for causing the computer to send the discovery message cause the computer to send the discovery message periodically.

21. The computer program product of claim 20 wherein the instructions for causing the computer to send the discovery message cause the computer to send the discovery message approximately every five seconds.

22. The computer program product of claim 18 wherein the designated IP address is configured to cause the UPS to turn on DHCP if DHCP is off.

23. The computer program product of claim 18 further comprising instructions for causing the computer to update a device list with device information contained in the responsive communication that is different than information stored by the computer.

24. The computer program product of claim 18 further comprising instructions for causing the computer to update a status indication associated with the responding UPS in accordance with status information contained in the responsive communication and to cause the computer to display indicia of the status of the responding UPS.
